(19) United States
(12) Patent Application Publication
(10) Pub. No.: US 2021/0102674 A1
(43) Pub. Date: Apr. 8, 2021

(54) BLOW-OUT ELECTRONIC CANDLE

(71) Applicant: Nantong Yatai Candle Arts & Crafts Co., Ltd, Nantong City, Jiangsu (CN)

(72) Inventor: Yingqi DING, Nantong City, Jiangsu (CN)

(21) Appl. No.: 16/466,014

(22) PCT Filed: Apr. 23, 2019
(86) PCT No.: PCT/CN2019/083806

§ 371 Date: May 31, 2019

(30) Foreign Application Priority Data
May 10, 2018 (CN) 201810441003.7

(51) Int. Cl. F21S 10/04; F21S 6/00; F21S 9/02; F21V 23/04; F21V 33/00

(52) U.S. Cl. CPC F21S 10/046; F21S 6/001; F21Y 2115/10; F21V 23/04; F21V 33/0088; F21S 9/02

(57) ABSTRACT

The invention discloses a blow-out electronic candle, comprising a candle body, whose inside is a cavity, and the upper surface is a mounting hole, a battery case is disposed in the bottom, a control board on the upper surface of the case; a flame crown structure is embedded in the mounting hole, comprising a flame crown supporting holder, a twin lamp holder and a flame crown; the crown is mounted in the supporting holder, the twin lamp holder is snapped on the side wall, an illuminant is installed inside; the illuminant illuminates in a blinking pattern, forming beating highlights; a microphone opposite the air inlet of the supporting holder is mounted at the inside, so that the airflow triggers the microphone, controlling the illuminant on and off, simulating to be blown out. The invention simulates the swing form of the flame crown, and increases the simulation form of blow-out.

### FIELD OF THE INVENTION

The invention relates to an electronic candle, and in particular, to a blow-out electronic candle with a swinging candlewick.

### BACKGROUND

The candle is a decorative daily necessities. The traditional candle is mainly used for lighting and is realized by burning wax oil. However, the burning makes the candle become shorter and exhausted. At the same time, with the development of society, the function of the candle is not limited to lighting, but also plays a role in decorating and increasing atmosphere. At birthday parties, friends gathering, lovers' date, a few candles can be lighted, and the flashing candlelight can increase a romantic atmosphere, but the burning candle is not only troublesome, but also has great security risks.

### SUMMARY OF THE INVENTION

Objective of the invention: the objective of the invention is to solve the deficiencies in the prior art, and to provide a blow-out electronic candle, which not only simulates the swing form of the flame crown, but also increases the simulation form of blow-out.

Technical solutions: A blow-out electronic candle, comprising a candle body; the candle body is internally provided with a cavity, and the upper surface thereof is provided with a mounting hole; a battery case is disposed in the bottom of the electronic candle body in the cavity, and a control board is mounted on the upper surface of the battery case; a flame crown structure is embedded in the mounting hole, wherein the flame crown structure comprises a flame crown supporting holder, a twin lamp holder and a flame crown; the flame crown is mounted in the flame crown supporting holder, and the twin lamp holder is snapped on the side wall of the flame crown supporting holder, and an illuminant that is electrically connected to the control board is installed inside thereof; the illuminant illuminates in a blinking pattern to form beating highlights on the flame crown; a microphone directly opposite the air inlet of the supporting holder is mounted at the inside of the flame crown supporting holder, so that the externally entering airflow triggers the microphone to control the illuminant to be turned on and off, which is simulated to be blown out.

Preferably, the flame crown supporting holder is a cylindrical structure with a bottom plate, and the outer wall thereof is provided with a limiting ring matching the mounting hole of the candle body to limit; the bottom plate is provided with a snapping slot, and the region deviating from the snapping slot is provided with a microphone mounting hole; the microphone is embedded in the microphone mounting hole, and the bottom of the flame crown is snapped in the snapping slot.

Preferably, the flame crown comprises a flame sheet and a circular baffle perpendicular to the flame sheet, and the circular baffle is provided with an opening; when the flame sheet is inserted into the snapping slot, the circular baffle is snapped in the flame crown supporting holder to form an upper surface, meanwhile, the illuminant in the twin lamp holder is irradiated onto the flame sheet through the opening.

Preferably, the flame crown supporting holder is a cylindrical structure, and the inner wall thereof is provided with a convex T-shaped supporting sheet; the upper surface of the supporting sheet is provided with a curved groove; the flame crown is sleeved on the T-shaped supporting sheet, and the microphone is fixed on the inner wall of the flame crown supporting holder.

Preferably, the flame crown comprises an upper portion, a middle portion and a lower portion that are integrated with each other; the upper portion is a flame-shaped sheet structure; the middle portion is an annular structure, and the top of the ring is provided with a convex thimble; the lower portion is a trapezoidal bearing block; the flame crown is sleeved on the T-shaped supporting sheet through the intermediate annular structure, and is supported in the curved groove via the thimble as the supporting point; when the flame-shaped sheet structure is shaken by an external force, the thimble is rocked in the curved groove to form a simulated swing with the lower trapezoidal bearing block.

Preferably, the twin lamp holder is provided with two lamp slots; an illuminant is mounted in both of the lamp slots, and the illuminant is electrically connected to the control board.

Preferably, the two illuminants are in the blinking pattern, and the blinking frequencies thereof are inconsistent, so that the light irradiated onto the flame sheet is flickering as the flame crown is swinging.

Preferably, the bottom of the battery case is embedded with a power toggle switch that is electrically connected to the control board to realize power supply control.

Advantageous effects: the blow-out electronic candle disclosed by the invention has following advantageous effects.

Another microphone is added inside the flame crown, which can make the electronic candle have a simulation effect of blow-out without affecting the appearance. At the same time, according to the structure of the flame crown, the installation position of the microphone can be adjusted to ensure that it is facing the blow-out port and to improve the sensing sensitivity.

For the simulation of the flame crown: by controlling the flickering frequency of the two lamps, the light irradiated onto the flame sheet is flickering, as if the light is flickering when the breeze blows the flame, and the simulation degree is high.

Meanwhile, the flame crown of the wind-swinging type can be adopted, so that it not only has the effect of light flickering, but also the flame sheet itself swings with the wind, which further enhances the simulation effect.

### DESCRIPTION OF THE DRAWINGS

FIG. 1 is a side cross-sectional view illustrating the electronic candle in embodiment 1 of the invention;

FIG. 2 is a top view illustrating the electronic candle in embodiment 1 of the invention;

FIG. 3 is a structural view illustrating the structure of the flame crown of the electronic candle in embodiment 1 of the invention;

FIG. 4 is a side cross-sectional view illustrating the electronic candle in embodiment 2 of the invention;

FIG. 5 is a top view illustrating the electronic candle in embodiment 2 of the invention;

FIG. 6 is a structural view illustrating the structure of the flame crown of the electronic candle in embodiment 2 of the invention.

### DETAILED DESCRIPTION OF THE PREFERRED EMBODIMENTS

The invention will be further described in detail hereinafter with reference to the drawings.

### Embodiment 1

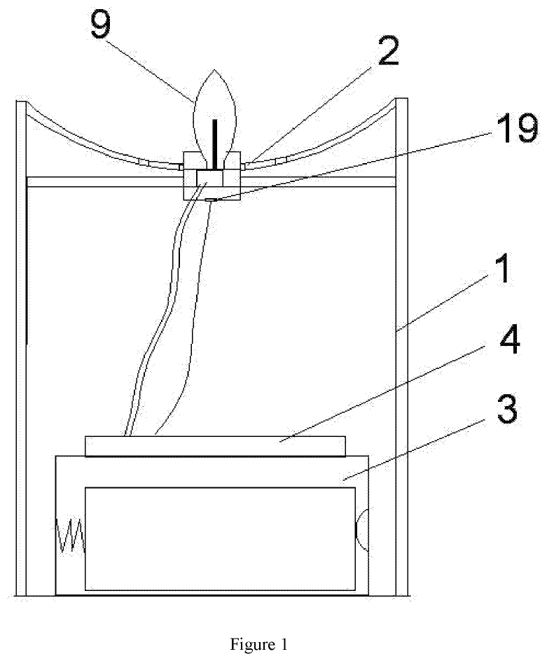

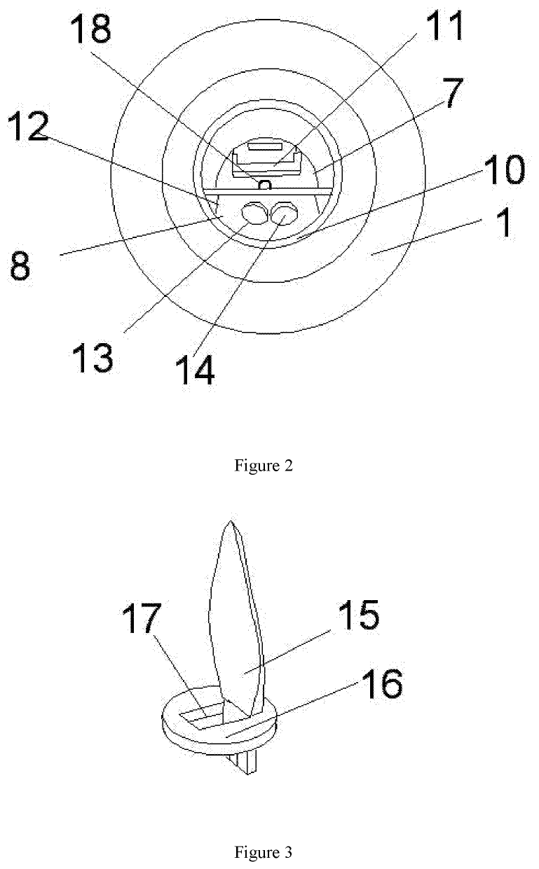

As shown in FIG. 1-3, a blow-out electronic candle, comprising an electronic candle body 1; the inside thereof is a cavity structure, and the upper surface thereof is provided with a mounting hole 2; a battery case 3 is disposed in the bottom thereof in the cavity, and a control board 4 is mounted on the upper surface of the battery case 3; the control board can be fixed on the battery case by a stud (a threaded hole is opened at the corresponding position of the battery case), or can be directly adhered to the battery case by hot melt adhesive; a flame crown structure is embedded in the mounting hole of the upper surface in the candle body.

The flame crown structure comprises a flame crown supporting holder 7, a twin lamp holder 8 and a flame crown 9; the outer wall of the flame crown supporting holder is provided with a supporting ring 10, and the upper and lower limits are carried out through the supporting ring when it is matched with the mounting hole; the flame crown supporting holder is provided with a bottom plate; the bottom plate is provided with a snapping slot 11, and the region deviating from the snapping slot 11 is provided with a microphone mounting hole 18; a microphone 19 that is electrically connected to the control board is embedded in the mounting hole; the side wall of the flame crown supporting holder facing the snapping slot is provided with an inclined groove 12, and the twin holder is embedded in the groove; the twin lamp holder 8 is provided with two lamp slots 13 therein, and both of the two lamp slots are provided with a threading hole extending to the side of the twin lamp holder; an LED lamp 14 is disposed in each of the two lamp slots, and the connecting wire of the LED lamp is connected from the threading hole to the control board 4; the flickering frequency of the two lamps is controlled to be inconsistent, so that the two LED lights are in a blinking pattern, and the light is irradiated onto the flame crown to form a flickering effect, as if the real flame is swinging.

The flame crown comprises a flame sheet 15 and a circular baffle 16 perpendicular to the flame sheet, and the circular baffle is provided with an opening 17; when the flame sheet is inserted into the snapping slot, the circular baffle is snapped in the flame crown supporting holder to form an upper surface, meanwhile, the LED lamp is irradiated onto the flame sheet through the opening; at the same time, when the air is blown to the opening, the microphone is triggered to generate a signal to the control board, thereby extinguishing or lighting the LED lamp to form a blow-out effect.

### Embodiment 2

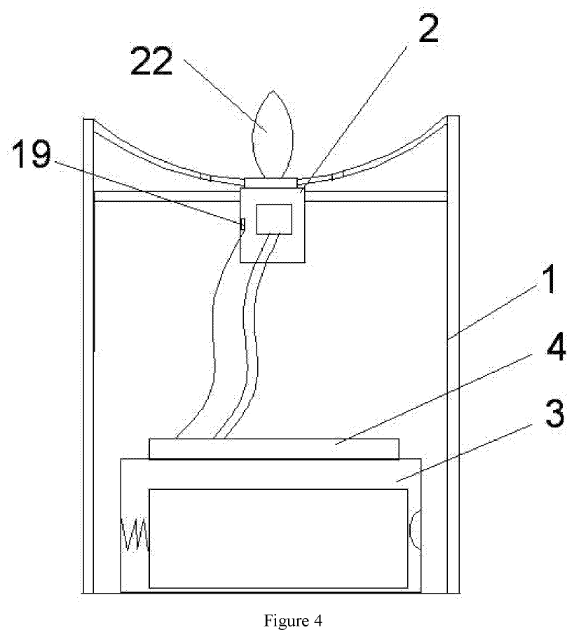

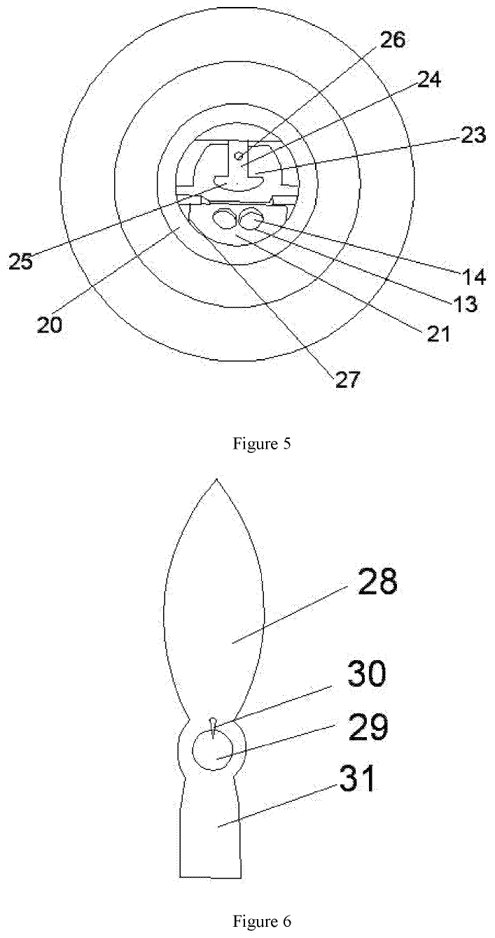

As shown in FIG. 4-6, a blow-out electronic candle, comprising an electronic candle body 1; the inside thereof is a cavity structure, and the upper surface thereof is provided with a mounting hole 2; a battery case 3 is disposed in the bottom thereof in the cavity, and a control board 4 is mounted on the upper surface of the battery case 3; the control board can be fixed on the battery case by a stud (a threaded hole is opened at the corresponding position of the battery case), or can be directly adhered to the battery case by hot melt adhesive; a flame crown structure is embedded in the mounting hole of the upper surface in the candle body.

The flame crown structure comprises a flame crown supporting holder 20 of cylindrical structure, a twin lamp holder 21 and a flame crown 22; the inner wall of the flame crown supporting holder 20 is provided with a convex T-shaped supporting sheet 23, and the T-shaped supporting sheet is provided with a supporting portion 24 and a limiting portion 25; the upper surface of the supporting portion 24 is provided with a curved groove 26; the side wall of the flame crown supporting holder 20 facing the T-shaped supporting sheet 23 is provided with an inclined groove 27, and the twin lamp holder 21 is embedded in the groove; the inner wall of the flame crown supporting holder 20 is also bonded with a microphone 19 that is electrically connected to the control board.

The flame crown 22 comprises an upper portion, a middle portion and a lower portion that are integrated with each other; the upper portion is a flame-shaped sheet structure 28; the middle portion is an annular structure 29, and the top of the ring is provided with a convex thimble 30; the lower portion is a trapezoidal bearing block 31; the flame crown is sleeved on the supporting portion 24 of the T-shaped supporting sheet through the intermediate annular structure 29, and is limited by the limiting portion; the length of the limiting portion is greater than the diameter of the annular structure; the flame crown is tilted into the limiting portion and then transferred to the supporting portion during installation; since the length of the limiting portion is greater than the length of the diameter thereof, the flame crown on the supporting portion does not fall; the flame crown sleeved on the supporting portion is supported in the curved groove via the thimble 30 as the supporting point; when the flame-shaped sheet structure is shaken by an external force, the thimble is shaken in the groove, not only it is flexible in swinging, but also the swinging position is always limited in the groove; at the same time, since the lower portion is provided with a bearing block, thus, no matter how the upper end swings, the center point of gravity is always on the vertical line, so that the flame crown will not be stuck or moved.

The structure of the twin lamp holder is the same as that in embodiment 1, and will not be described again; the two LED lamps are in the blinking pattern, and the blinking frequencies thereof are inconsistent, the light is irradiated onto the flame sheet facing directly the flame crown, and the flicker of different frequencies is flickering, as if the real flame is swinging.

The microphone in the structure of the invention can be used in any electronic candle (i.e., optical fiber type) in addition to the structure of the two embodiments of the invention, as long as the top of the electronic candle is provided with an air inlet, and the microphone is installed at any position below the air inlet.

The technical contents and features of the invention have been disclosed above. However, those skilled in the art will be able to make various substitutions and modifications based on the invention without departing from the spirit and scope of the invention. Therefore, the protection scope of the invention shall not be limited to the content disclosed in the embodiments, but shall include various alternatives and modifications without departing from the invention, which are covered by the claims of the invention.

1-8. (canceled)

9. A blow-out electronic candle, comprising a candle body; the candle body is internally provided with a cavity, and the upper surface thereof is provided with a mounting hole; a battery case is disposed in the bottom of the electronic candle body in the cavity, and a control board is mounted on the upper surface of the battery case; a flame crown structure is embedded in the mounting hole, wherein the flame crown structure comprises a flame crown supporting holder, a twin lamp holder and a flame crown; the flame crown is mounted in the flame crown supporting holder, and the twin lamp holder is snapped on the side wall of the flame crown supporting holder, and an illuminant that is electrically connected to the control board is installed inside thereof; the illuminant illuminates in a blinking pattern to form beating highlights on the flame crown; a microphone directly opposite the air inlet of the supporting holder is mounted at the inside of the flame crown supporting holder, so that the externally entering airflow triggers the microphone to control the illuminant to be turned on and off, which is simulated to be blown out.

10. The blow-out electronic candle according to claim 9, wherein the flame crown supporting holder is a cylindrical structure with a bottom plate, and the outer wall thereof is provided with a limiting ring matching the mounting hole of the candle body to limit; the bottom plate is provided with a snapping slot, and the region deviating from the snapping slot is provided with a microphone mounting hole; the microphone is embedded in the microphone mounting hole, and the bottom of the flame crown is snapped in the snapping slot;
the flame crown comprises a flame sheet and a circular baffle perpendicular to the flame sheet, and the circular baffle is provided with an opening; when the flame sheet is inserted into the snapping slot, the circular baffle is snapped in the flame crown supporting holder to form an upper surface, meanwhile, the illuminant in the twin lamp holder is irradiated onto the flame sheet through the opening.

11. The blow-out electronic candle according to claim 9, wherein the flame crown supporting holder is a cylindrical structure, and the inner wall thereof is provided with a convex T-shaped supporting sheet; the upper surface of the supporting sheet is provided with a curved groove; the flame crown is sleeved on the T-shaped supporting sheet, and the microphone is fixed on the inner wall of the flame crown supporting holder;
the flame crown comprises an upper portion, a middle portion and a lower portion that are integrated with each other; the upper portion is a flame-shaped sheet structure; the middle portion is an annular structure, and the top of the ring is provided with a convex thimble; the lower portion is a trapezoidal bearing block; the flame crown is sleeved on the T-shaped supporting sheet through the intermediate annular structure, and is supported in the curved groove via the thimble as the supporting point; when the flame-shaped sheet structure is shaken by an external force, the thimble is rocked in the curved groove to form a simulated swing with the lower trapezoidal bearing block.

12. The blow-out electronic candle according to claim 9, wherein the twin lamp holder is provided with two lamp slots; an illuminant is mounted in both of the lamp slots, and the illuminant is electrically connected to the control board.

13. The blow-out electronic candle according to claim 12, wherein the two illuminants are in the blinking pattern, and the blinking frequencies thereof are inconsistent, so that the light irradiated onto the flame sheet is flickering as the flame crown is swinging.

14. The blow-out electronic candle according to claim 9, wherein the bottom of the battery case is embedded with a power toggle switch that is electrically connected to the control board to realize power supply control.
